(19) United States
(12) Patent Application Publication
(10) Pub. No.: US 2013/0147455 A1
(43) Pub. Date: Jun. 13, 2013

(54) Power Management Method for Operating Electronic Device with Solar Energy

(71) Applicant: Yang Pan, Shanghai (CN)

(72) Inventor: Yang Pan, Shanghai (CN)

(21) Appl. No.: 13/323,762

(22) Filed: Dec. 12, 2011

(51) Int. Cl. G05F 1/46

(52) U.S. Cl. 323/284

(57) ABSTRACT

Power management method and apparatus for operating electronic devices with solar power is disclosed. Current-voltage characteristic of a solar system is measured by a controller. The maximum output power is determined accordingly. A power limiter is employed to limit the output power of solar system to be slightly below the maximum output power to prevent a sharp drop of the power caused by overdrawn of the power by the electronic device.

### CROSS-REFERENCE TO RELATED APPLICATIONS

Not applicable

### BACKGROUND

1. Field of Invention

This invention relates to electronic devices, specifically to a power management system and method for electronic devices with solar energy.

2. Description of Prior Art

Recently, solar energy has been used to power up portable electronic devices. However, given the characteristics of solar cells, it is relatively difficult to track the solar energy drawn from the solar cells to maintain relative stable solar energy output.

FIG. 1A illustrates an equivalent circuit for a solar cell with Vcell as an output voltage and Icell as an output current. FIG. 1B shows current-voltage characteristics of the solar cell. It is well known in the art that the output power of a solar cell depends on its operating point. There is an optimal operating point that is corresponding to the maximum output power of the cell. Overdrawn of the power from the solar cells by the electronic device may cause a rapid decreasing of output power. Therefore, it is desirable to have a power management system and method that enables solar cells to deliver optimized and stable output power to the electronic devices.

Sander et al suggests a method, in U.S. Pat. No. 8,004,113, to adjust output of a voltage converter according to current-voltage characteristics of a solar cell. A controller is employed to monitor status of an electronic device that draws power from the voltage converter. However, over-drawn of the output power from the solar cells may not be completely prevented by measuring and correcting the output power of the voltage converter.

A method of controlling temperature of a chip or a microstructure by employing a thermal feedback loop is known from an article by Pan (the present inventor) and Huijsing in Electronic Letters 24 (1988), 542-543. This circuit is theoretically appropriate for measuring physical quantities such as speed of flow, pressure, IR-radiation, or effective value of electrical voltage or current (RMS), the influence of the quantity grated integrated circuit (chip) to its environment being determined in these cases. In these measurements, a signal conversion takes place twice: from physical (speed of flow, pressure, IR-radiation or RMS value) to the thermal domain, and from the thermal to the electrical domain.

This known semiconductor circuit theoretically consists of a heating element, integrated in the circuit, and a temperature sensor. The power dissipated in the heating element is measured with the help of an integrated amplifier unit, an amplifier with a positive feedback loop being used, because of which the temperature oscillates around a constant value with small amplitude. In the known circuit the temperature will oscillate in a natural way because of the existence of a finite transfer time of the heating element and the temperature sensor with a high amplifier-factor

It is desirable to apply the above mentioned thermal feedback loop in a form of semiconductor integrated circuit to provide a reliable method for the electronic device to draw stable output power from solar cells.

### SUMMARY OF THE INVENTION

It is therefore an object of the present invention to provide a method and apparatus for an electronic device to draw a stable output power from solar cells.

In one embodiment, a power limiter is having an input coupled to an output of a solar energy generation system (solar system) and having an output coupled to an electronic device. The power limiter is constructed based upon a thermal feedback loop implemented in a semiconductor integrated circuit. An incoming DC power is modulated by a PWM or a bit stream signal. The modulated power may be converted back into DC form by a converter. A heating element on a chip or on a microstructure receives a proportional portion of the power from the converter. Temperature of the chip is measured by a temperature sensor. The temperature of the chip is controlled by the thermal feedback loop to oscillate around a predetermined value. A comparator takes one input from the output of the temperature sensor and takes another input from a reference generated by a controller. An output of the comparator in the PWM or in the bit stream form is coupled to DC power modulator to modulate the incoming DC power. The output power of the power limiter is determined by the temperature of the chip set by the reference.

In a preferred embodiment, the controller measures current-voltage characteristics of the solar system and determines optimal operating point for the maximum output power. The controller may strategically set the power limit of the power limiter to be slightly below the maximum power. Therefore, the solar system will never be driven to pass the optimal operating point to cause a sharp drop in the output power.

### BRIEF DESCRIPTION OF THE DRAWINGS

For a more complete understanding of the present invention and its various embodiments, and the advantages thereof, reference is now made to the following description taken in conjunction with the accompanying drawings.

FIG. 1A is a diagram illustrating an equivalent circuit of a typical solar cell.

FIG. 1B is a diagram illustrating characteristics of a typical solar cell as shown in FIG. 1A.

FIG. 2 is a schematic diagram illustrating apparatus for operating an electronic device with solar energy.

FIG. 3 is a schematic diagram illustrating a power limiter based upon a thermal feedback loop in one embodiment that employs a PWM signal.

FIG. 4 is a schematic diagram illustrating a power limiter based upon a thermal feedback loop in an alternative embodiment that employs a bit stream signal.

FIG. 5 is a schematic diagram illustrating a power limiter based upon an electrical feedback loop in an alternative embodiment that employs a bit stream signal.

FIG. 6 is a flowchart illustrating the power management method for operating an electronic device with solar energy.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

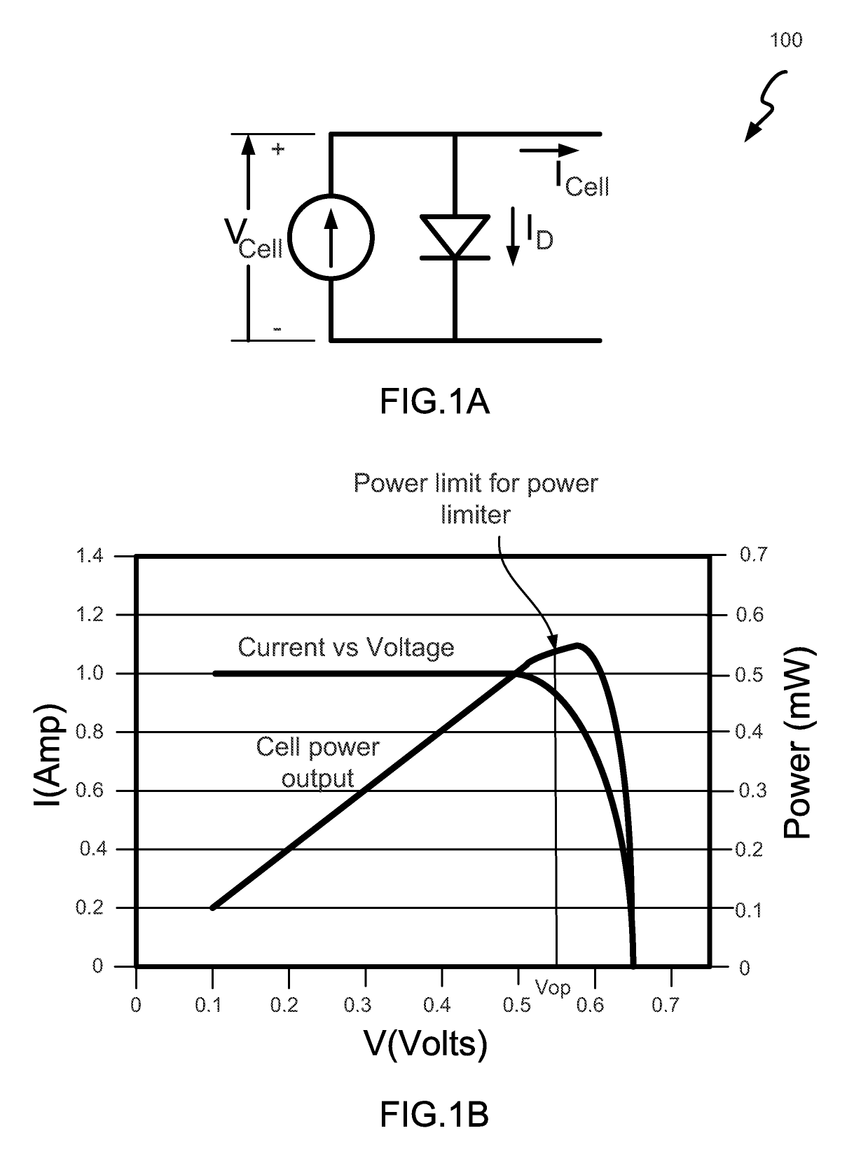

FIGS. 1A and B are a schematic diagram of an equivalent circuit of a solar cell and a current-voltage characteristic of the cell. In one embodiment, an operating point of the solar cell may be strategically selected to have the output power slightly below the maximum output power of the solar cell. By implementing such a strategy, an electronic device (load) will never drive the solar cell to pass the optimal point to cause the output power of solar cell to drop sharply. Since output power of the solar cell depends on a time of day and on weather conditions, the current-voltage relationship may be measured regularly according to a predetermined algorithm to adjust the power limit of the power limiter accordingly. In another embodiment, the power limit may be set as the measured maximum power. Cautions must be taken in a control system to prevent the overdrawn of the power from solar cells to cause unstable output power.

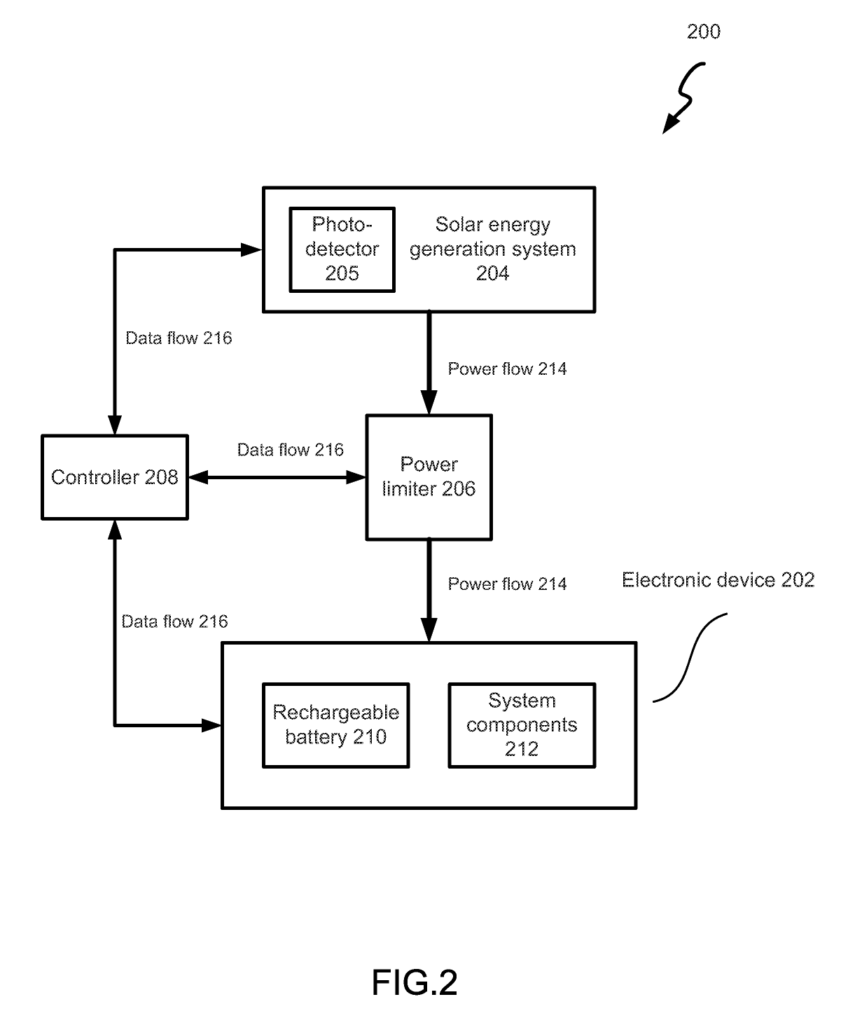

FIG. 2 is a schematic diagram illustrating an exemplary apparatus for operating the electronic device with solar energy. System 200 comprises an electronic device 202 that is taken as a portable electronic device exemplarily, a solar energy generation system 204 (solar system) and a power limiter 206. The output power of solar system 204 is coupled to an input of power limiter 206. A controller 208 is coupled to power limiter 206. Controller 208 is also coupled to solar system 204 and to electronic device 202. Power limiter 206 is programmable by controller 208. Controller 208 may change the power limit of power limiter 206 by sending a control signal to power limiter 206 through a data or a communication link The link may be a wired link. The link may also be a wireless link (e.g., a Bluetooth type of connection). Output of power limiter 206 is coupled to electronic device 202 to power the device.

Controller 208 is having capability to measure current-voltage characteristics of solar system 204 at a predetermined time or in a predetermined frequency according to a predetermined algorithm. Controller 208 may have a program stored in a file storage system to execute such a procedure. Controller 208 has a capability to determine maximum output power based upon the measured current-voltage characteristics. Controller 208 may comprise hardware, software and firmware and may be implemented based upon a microprocessor or microcontroller. Controller 208 may also be implemented as a special purpose processor. In one aspect of the present invention, controller 208 is an independent device. In another aspect, controller 208 may be integrated with power limiter 206. In yet another aspect, controller 208 may be integrated with electronic device 202. In still another aspect, controller 208 may be a part of solar system 204. All such variations fall into the scope of the present invention.

Solar system 204 may include one or more solar cells. Solar system 204 may be a part of electronic device 202. Solar system 204 may be an external device to electronic device 204 and may be connected or be disconnected from electronic device 202. Solar system may further comprise booster circuits to regulate output voltage (current) to a desired level to power electronic device 202. Optionally, solar system 204 may comprise a photodetector 205 that is manufactured by essentially the same process steps as solar cells in solar system 204. Photodetector 205 has same current-voltage characteristics of solar system 204 but has much smaller in size. The maximum power of solar system 204 may be derived from measured current-voltage characteristics of photodetector 205 based upon area ratio between solar cells and photodetector 205. The ratio may also be calibrated by controller 208 and be stored in a file storage system of controller 208. Controller 208 is coupled to photodetector 205 to measure its current-voltage characteristics. Controller 208 may be coupled to solar system 204 through a wired connection. Controller 208 may also be coupled to solar system 204 through a wireless connection, such as, for example, through a short range communication link such as a Bluetooth or ZigBee type of connection. Controller 208 may even be coupled to solar system 204 through an optical communication link. The use of an independent photodetector 205 enables controller 208 to measure and to analyze the current-voltage characteristics in real time base and to adjust the power limit of power limiter 206 timely. It should be noted that inclusion of photodetector 205 is not essential for system 200 operations. The current-voltage characteristics of the solar system 204 may be determined directly by measuring one or more solar cells.

Electronic device 202 comprises a rechargeable battery 210 according to the preferred embodiment. In general, rechargeable battery 210 may be replaced by another power source (e.g., power from a power grid when an outlet is available). Electronic device 202 further comprises system components 212. System components 212 include but are not limited to a data processing unit, a storage unit and a user interface. Electronic device 202 may include but is not limited to one of following devices: 1) a media player; 2) computing device; 3) a communication device; 4) a tablet computer; 5) a laptop computer; 6) a smart phone; 7) a game console; and 8) a digital camera.

In one aspect, controller 208 sets the output power of power limiter 206 to a predetermined value according to the measured current-voltage characteristics of solar system 204. The predetermined value may be a value below the maximum output power according to a preferred implementation. The value may be only slightly below the maximum power (e.g. 0.1% to 25% below the maximum power in an exemplary manner). The predetermined value may also be the maximum output power of solar system 204. By setting the power limit to be below the maximum output power, electronic device 202 will not have an opportunity to overdraw the power from solar system 204. It should be noted that output power of solar system 204 may change time to time depending on a time of day and also on weather conditions. Therefore, it is necessary to measure the current-voltage characteristics in a predetermined frequency, such as, for example, in every five minutes to adjust the power limit of power limiter 206 timely.

As shown in FIG. 2, power flow 214 flows from solar system 204 to power limiter 206 and to electronic device 202. Data flow 216 may flow from controller 208 to solar system 204, to power limiter 206 and to electronic device 202 and vice versa.

In one aspect of the present invention, if the output power from power limiter 206 is more than sufficient to power electronic device 202, surplus power may be directed to charge rechargeable battery 210. According to one embodiment of the present invention, another power limiter (not shown in FIG. 2) may be added to the power path that is directed to charge battery 210. The power limiter may also be controlled by controller 208. The power limiter will prevent overdrawn of power for charging up battery 210.

In another aspect, if the output power from power limiter 206 is insufficient to power electronic device 202, rechargeable battery 210 or another power source will be employed to supply additional power for electronic device 202.

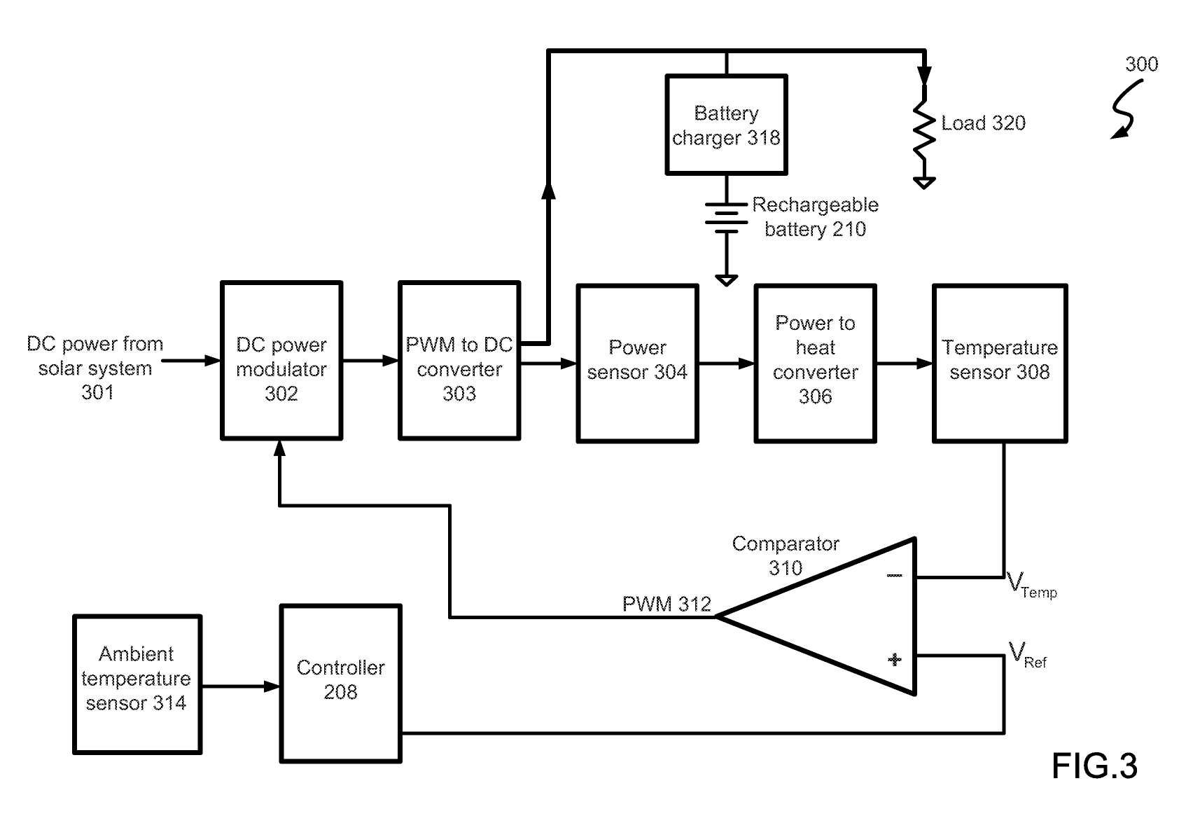

FIG. 3 shows an exemplary power limiter based upon a thermal feedback loop. In the embodiment, power limiter 300 comprises an incoming DC power 301 that is drawn from solar system 204. DC power 301 is coupled to a first input of DC power modulator 302. In one aspect of the embodiment, block 302 modulates DC power 301 by a PWM signal 312. Output of the power in PWM form is converted back into DC power by PWM to DC converter 303. One of the outputs of block 303 is coupled to a power sensor 304 that receives a predetermined proportional portion of output power of block 303. Power sensor 304 may comprise a voltage sensor and a current sensor (not shown in FIG. 3). Another output of block 303 is coupled to a load 320 (electronic device 202). The same output may also be coupled to rechargeable battery 210 through battery charger 318. The output power is determined by duty cycle ratio of the PWM signal.

In another aspect of the embodiment, power sensor 304 may draw the predetermined portion of power from block 302 directly (not shown in FIG. 2). The predetermined portion of power received by DC power sensor 304 is coupled to power to heat converter (heating element) 306. Heating element 306 may be a resistor. Heating element 306 may also be an active device, such as, for example, a Metal-Oxide-Semiconductor-Field-Effect-Transistor (MOSFET) or a bipolar transistor. Temperature sensor 308 measures temperature of the chip (microstructure) that includes heating element 306 and temperature sensor 308. Comparator 310 takes one input from the output of temperature sensor 308 and takes another input from a reference generated from controller 208. The output of comparator 310 in PWM form (312) is coupled to a second input of DC power modulator 302 to modulate the incoming DC power 301 and therefore complete the thermal feedback loop. The temperature of the chip (microstructure) will oscillate around a small value set by the reference. DC power modulator 302 converts the DC power into the power in PWM form.

The maximum output power of DC power modulator 302 is determined by the reference that sets a level around which the chip's temperature will oscillate. To sustain a higher temperature, the power sensor 304 will need to draw more power proportionally from blocks 303. The reference is determined by controller 208. Controller 208 may determine the reference based upon the determined maximum power from measured current-voltage characteristics of solar system 204. Controller 208 may determine the reference according to the strategy to set the power limit at a value slightly below the maximum output power of the solar system 204 to prevent overdrawn of the output power by electronic device 202 to cause a sharp drop in output power of solar system 204.

It should be noted that the power required to sustain the temperature level, around which the chip's temperature oscillates, also depends on an ambient temperature. At a lower ambient temperature, it requires more power to heat the heating element to maintain the temperature level. At a higher ambient temperature, less power is required. In one aspect of the embodiment, an ambient temperature sensor 314 is used to measure the ambient temperature. The measurement results are sent to controller 208. Ambient temperature may be measured regularly. Temperature sensor 314 may be a sensor independent of the integrated circuit or the chip. Temperature sensor 314 may also be a part of the integrated circuit or the chip that will require an appropriate thermal isolation between temperature sensor 308 and temperature sensor 314. Such thermal isolation techniques are known in the art. Ambient temperature sensor 314 may even be integrated with controller 208.

The chip (microstructure) is associated with a thermal capacity. It requires a predetermined amount of power to heat the chip to a predetermined temperature above the ambient temperature. The required temperature difference caused by the heating power is further converted to the reference voltage by controller 208 based on characteristics of temperature sensors 308 and 314. Since power sensor 304 draws a proportional portion of power from block 303, a predetermined relationship between the output power of block 303 and the reference voltage may be established and be stored in a storage system of controller 208.

There may be various ways to integrate components of power limiter 300 at different integration levels. At a minimum level, 306 and 308 are integrated in a single chip or in a single microstructure. At a higher level, 310 may also be integrated (e.g., 306, 308 and 310 in a single chip). At even higher levels, 302, 303, 304, 208, and 314 may also be integrated (e.g., 302, 303, 304, 306, 308, 310, 208 and 314 in a single chip). All such variations with different levels of integration fall within the scope of inventive concepts of the present invention.

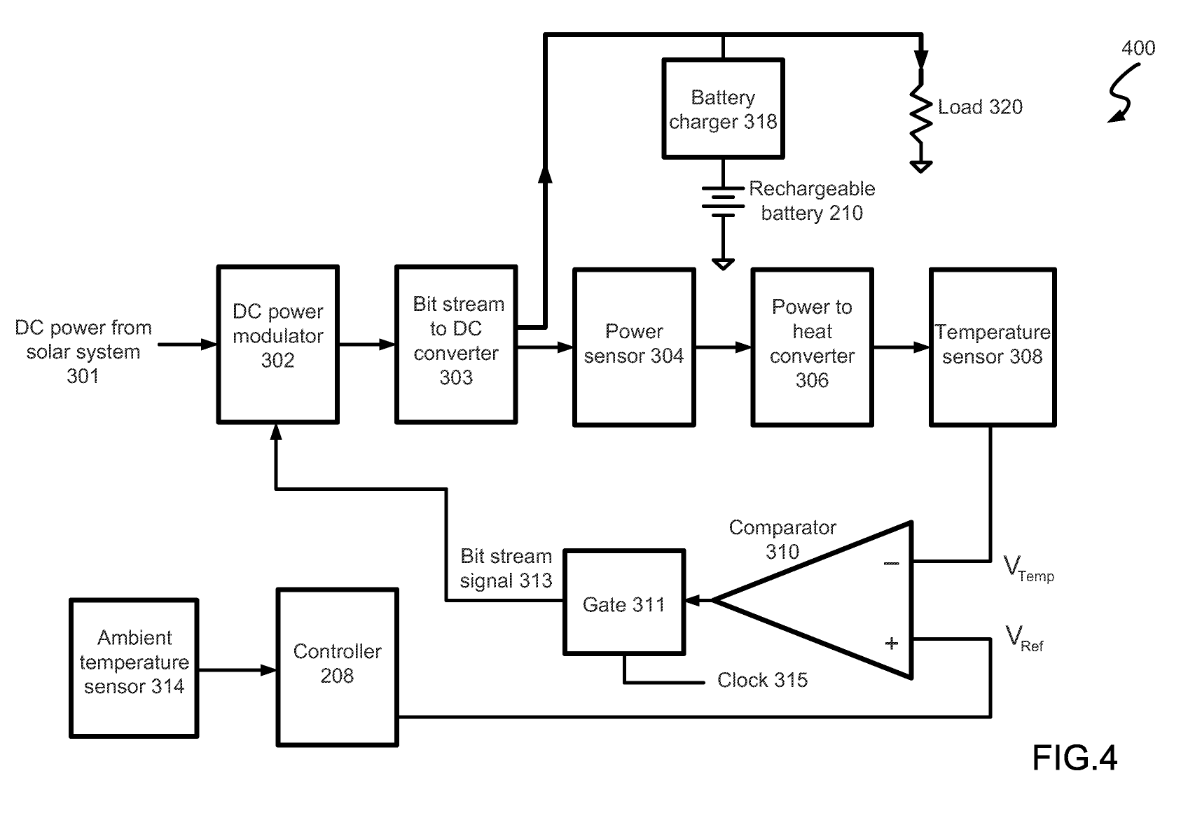

FIG. 4 illustrates an alternative embodiment of the power limiter (400). In the embodiment, the incoming DC power 301 is coupled to a first input of DC power modulator 302, wherein the incoming DC power 301 is modulated by a bit stream signal 313. An output of block 302 is coupled to bit stream to DC converter 303 to convert the power modulated by the bit stream signal back into the DC power. A predetermined proportional portion of the output power is received by power sensor 304 from one of the outputs of block 303 and is converted to heat by power to heat converter or heating element (306). DC power is delivered to load 320 (electronic device 202) through another output of block 303. The output power may also be employed to charge rechargeable battery 210 through battery charger 318.

Comparator 310 takes an output of temperature sensor 308 as a first input and a reference generated by controller 208 as a second input. The output of comparator 310 is coupled to a first input of gate 311 which has a second input connected to a clock signal 315. The output of gate 311 in bit stream form is coupled to the second input of DC power modulator 302. The thermal feedback loop is completed. The reference generated by controller 208 sets a level of temperature around which the chip's temperature oscillates and, therefore, sets the output power of block 302 and block 303.

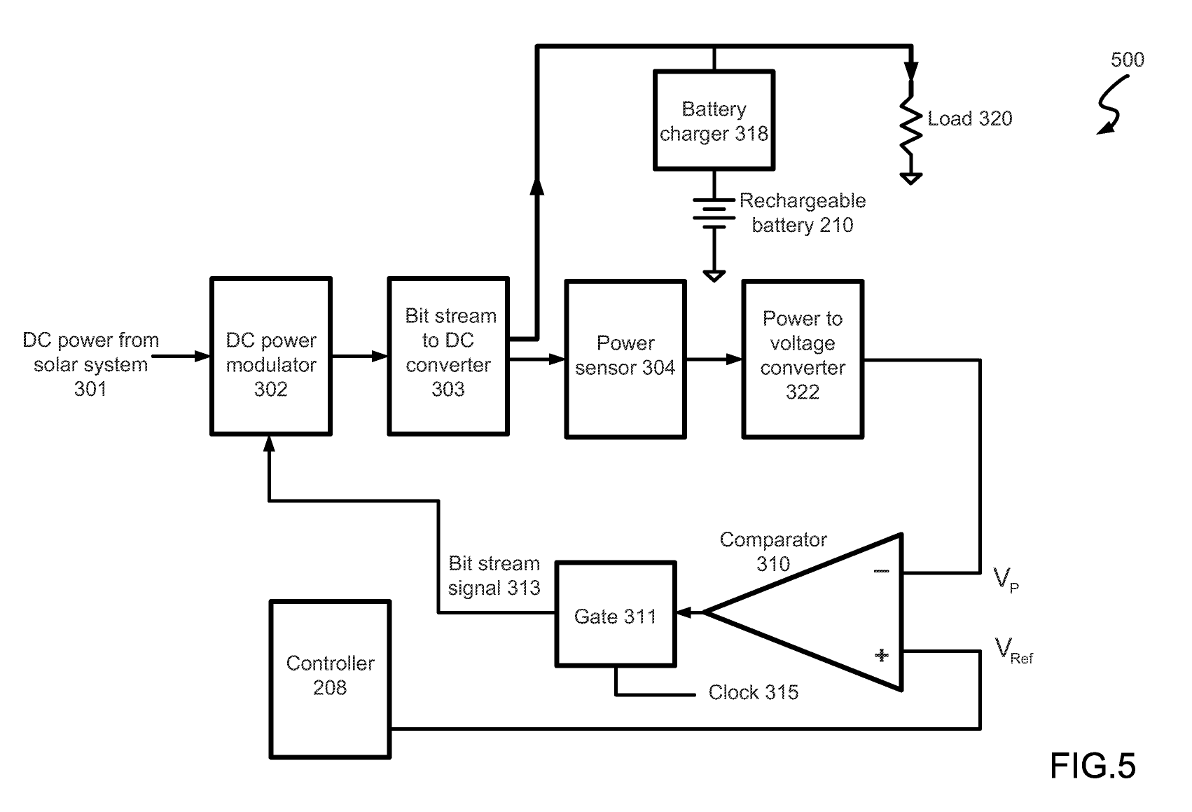

FIG. 5 illustrates yet another alternative embodiment of the power limiter (500). In the embodiment, the incoming DC power 301 is coupled to a first input of DC power modulator 302, wherein the incoming DC power 301 is modulated by a bit stream signal 313. An output of block 302 is coupled to bit stream to DC converter 303 to convert the power modulated by the bit stream signal back into DC power. A predetermined proportional portion of the output power is received by power sensor 304 from one of the outputs of block 303 and is converted to a voltage by power to voltage converter 322. DC power from another output of block 303 is delivered to load 320 (electronic device 202). The output power may also be employed to charge rechargeable battery 210 through battery charger 318.

Comparator 310 takes an output of power to voltage converter 322 as a first input and a reference generated by controller 208 as a second input. The output of comparator 310 is coupled to a first input of gate 311 which has a second input connected to a clock signal 315. The output of gate 311 in the bit stream form is coupled to the second input of DC power modulator 302. The output power of block 302 is determined by pulse counts of the bit stream signal in a predetermined time interval. The output voltage of block 322 oscillates around the reference voltage generated by controller 208. The pulse counts of the bit stream signal within a predetermined time interval determine output power of block 302 and block 303.

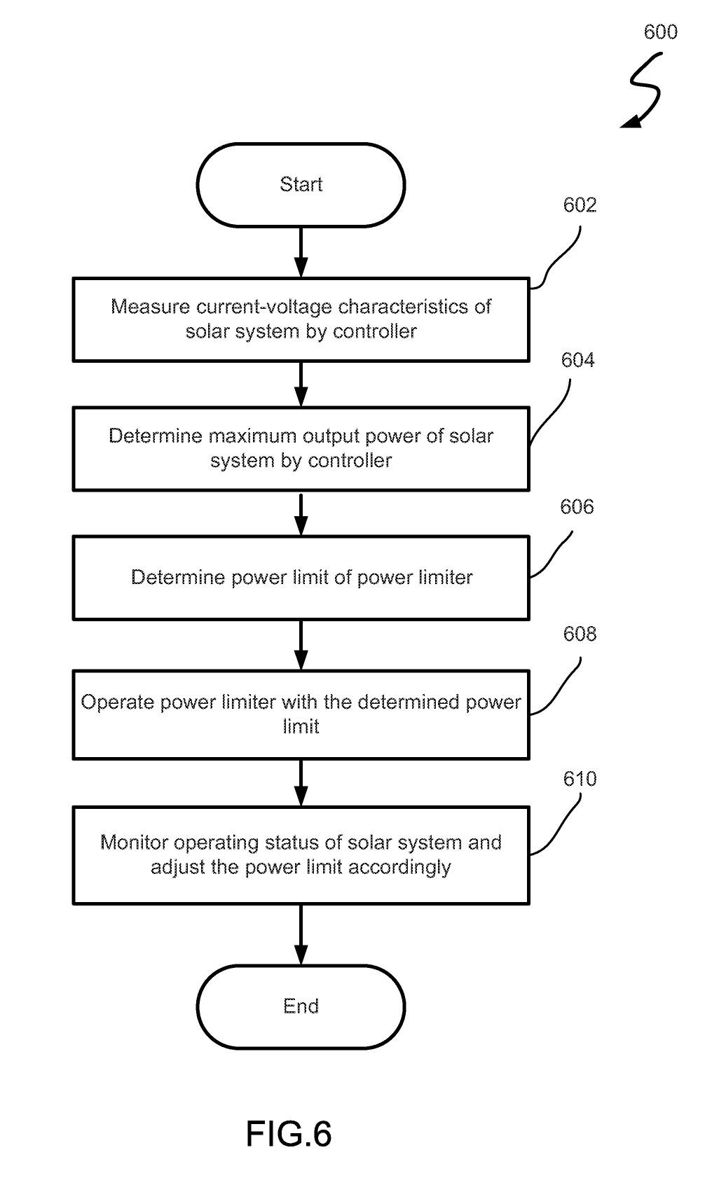

FIG. 6 is a flowchart illustrating the power management method for operating an electronic device with solar energy. Process 600 starts with step 602 that current-voltage characteristic of solar system 204 is measured by controller 208. The measurement may be based on one or more solar cells in solar system 204. The measurement may also be based on photodetector 205 that is manufactured by essentially the same process steps as the solar cells'. The maximum output power of solar system 204 is determined by controller 208 (604). If photodetector 205 is employed, a correlation factor may be predetermined by a calibration procedure. Controller 208 may include a program that executes an operation of measuring the current-voltage characteristics and determining the operating point for maximum output power. Results of the measurements, the operating point and maximum output power may be stored in a storage unit of controller 208 such as in a cache. Power limit of power limiter 206 is subsequently determined by controller 208 (606). The data and control signal may be exchanged between solar system 204 and controller 208 through a wired or a wireless communication link. In a preferred implementation, the power limit is set to be below the maximum output power of solar system 204 at a specific moment. Based upon the current-voltage characteristics as shown in FIG. 1B, such a strategy will prevent electronic device 202 overdrawn of output power from solar system 204 to cause a sharp drop in the output power and to bring solar system 204 into an unstable operation regime. In another implementation, the power limit may also be set by controller 208 as the maximum output power of solar system 204. Controller 208 sends a control signal to power limiter 206. The control signal includes a reference for comparator 310. The reference may further be adjusted based upon the ambient temperature measured by ambient temperature sensor 314. Power limiter 206 operates according to the control signal sent by controller 208 (608). Electrical power drawn by electronic device 202 is limited by power limiter 206. Since output power of solar system 204 changes according to a time of day and to weather conditions, controller 208 monitors operation status of solar system 204 by measuring the current-voltage characteristics in a predetermined frequency according to a predetermined algorithm (610). The power limit of power limiter 206 may be adjusted time to time according to the measured current-voltage characteristics.

While the invention has been disclosed with respect to a limited number of embodiments, numerous modifications and variations will be appreciated by those skilled in the art. Additionally, although the invention has been described particularly with respect to portable electrical devices, it should be understood that the inventive concepts disclosed herein are also generally applicable to other electronic systems, such as, for example, lighting system, home electrical appliances or production tools powered by solar energy. The inventive concepts are also applicable to other appliances and systems that consume directly AC power. An additional DC/AC converter may be added. Furthermore, the present inventive concepts are applicable to any implementation of power limiters. It is intended that all such variations and modifications fall within the scope of the following claims:

1. A system comprising:
(a) a solar energy generation system comprising one or a plurality of solar cells;
(b) an electronic device configured to receive power from the solar energy generation system;
(c) a controller configured to provide a means of determining maximum output power from the solar energy generation system; and
(d) a power limiter providing a means of limiting power drawn by the electronic device from the solar energy generation system to be set at a predetermined value below said maximum output power to prevent an event of overdrawn of output power from the solar energy generation system to cause a sharp drop of the output power.

2. The system as recited in claim 1, wherein said power limiter is constructed based upon a thermal feedback loop.

3. The system as recited in claim 2, wherein said thermal feedback loop of said power limiter further comprising a DC power modulator, a power sensor, a heating element, a temperature sensor, and a comparator, wherein said comparator taking output of the temperature sensor as a first input and taking a reference determined by the controller as a second input and having a PWM (pulse width modulation) signal as an output that is coupled to an input of the DC power modulator, wherein said reference is additionally determined by an ambient temperature measured by an ambient temperature sensor.

4. The system as recited in claim 3, wherein said thermal feedback loop of said power limiter further comprising a gate including a first input coupled to the output of the comparator, a second input coupled to a clock signal and an output coupled to the DC power modulator, wherein said gate converts the PWM signal into a bit stream signal.

5. The system as recited in claim 3 wherein at least said heating element and said the temperature sensor are integrated in a single chip or in a single microstructure.

6. The system as recited in claim 5, wherein said microstructure is manufactured by a micromachining technology.

7. The system as recited in claim 3, wherein output power from the DC power modulator is further converted to DC form before the power is delivered to the electronic device as a load.

8. The system as recited in claim 1, wherein said solar energy generation system further comprising a photodetector, wherein said photodetector is manufactured by essentially the same process steps as the solar cells'.

9. The system as recited in claim 1, wherein said electronic device further comprising a portable electronic device, wherein said portable electronic device further comprising a rechargeable battery that may provide additional power to the portable electronic device or may receive power from the solar energy generation system through the power limiter.

10. The system as recited in claim 1, wherein said power limiter is constructed based upon an electrical feedback loop that generates a bit stream signal to modulate incoming power from the solar energy generation system.

11. A power management method for an electronic device powered by a solar energy generation system, the method comprising:
(a) determining maximum output power of the solar energy generation system by a controller, wherein said solar energy generation system further comprising one or a plurality of solar cells;
(b) generating a control signal comprising a reference signal by the controller, wherein said control signal is sent to a power limiter that having an input coupled to output of solar energy generation system and having an output coupled to the electronic device;
(c) setting an output power limit of said power limiter according to the control signal, wherein said power limit may be set to be a predetermined value that is below the maximum output power of the solar energy generation system to prevent overdrawn of the power by the electronic device to cause a sharp drop of the output power; and
(d) repeating steps (a) to (c) according to a predetermined frequency.

12. The method as recited in claim 11, wherein said method further comprising determining maximum output power by measuring current-voltage characteristics of a photodetector, wherein said photodetector is manufactured according to essentially the same process steps as the solar cells'.

13. The method as recited in claim 11, wherein said power limit of said power limiter is determined by employing a thermal feedback loop implemented in an integrated semiconductor circuit that generates a PWM (pulse width modulation) signal or a bit stream signal to modulate an incoming DC power from the solar energy generation system.

14. The method as recited in claim 11, wherein said power limit of said power limiter is determined by employing an electrical feedback loop implemented in an integrated semiconductor circuit that generates a bit stream signal to modulate an incoming DC power from the solar energy generation system.

15. The method as recited in claim 11, wherein additional power from a rechargeable battery is employed to power the electronic device if power drawn from the solar energy generation system is insufficient for operations of the electronic device.

16. The method as recited in claim 11, wherein said method further comprising directing surplus power from the solar energy generation system to charge a rechargeable battery.

17. An apparatus for operating an electronic device with solar energy comprising:
(a) means of generating electricity power by a solar energy generation system;
(b) means of determining maximum value of said power by a controller;
(c) means of limiting power drawn by the electronic device to be below said maximum value by a power limiter; and
(d) means of adjusting said limiting power drawn according to measured changes of said maximum value of said power.

18. The apparatus as recited in claim 17, wherein said means of limiting power drawn further comprising limiting power drawn based upon a thermal feedback loop that comprises a means of forcing temperature of a chip or a microstructure to oscillate around a predetermined value.

19. The apparatus as recited in claim 18, wherein said predetermined value of the temperature is determined by a reference generated from a controller based upon said maximum output power.

20. The apparatus as recited in claim 19, wherein said reference is further determined by an ambient temperature measured by an ambient temperature sensor.
